(19) United States
(12) Patent Application Publication
(10) Pub. No.: US 2011/0174509 A1
(43) Pub. Date: Jul. 21, 2011

(54) FIRE PROTECTION SYSTEM FOR EXPANDED POLYMERS

(75) Inventors: Heribert QUANTE, Marienmuenster (DE); Friedhelm VIELMEYER, Muenster (DE); Jürgen WEIDINGER, Muenster (DE)

(73) Assignee: ARMACELL ENTERPRISE GMBH, Muenster (DE)

(21) Appl. No.: 13/008,722

(22) Filed: Jan. 18, 2011

(30) Foreign Application Priority Data
Jan. 18, 2010 (EP) 10 150 938.8

(51) Int. Cl. A62C 3/00; B32B 3/26; B32B 5/18; B32B 7/12; B29C 47/04; A47B 81/06

(52) U.S. Cl. 169/45; 428/319.1; 442/221; 442/315; 442/1; 428/317.1; 156/279; 181/198

(57) ABSTRACT

The present invention relates to versatile multi-layer (A)(B) coating systems for anti-flame purposes especially for protection of expanded organic polymers (C) leading to improved fire retardant properties together with low smoke generation, the process for manufacturing of such systems, the application of such systems on substrates and the use of such systems and resulting composites.

### BACKGROUND OF THE INVENTION

1. Field of the Invention

The present invention relates to versatile multi-layer coating systems for anti-flame and smoke suppression purposes especially for protection of expanded organic polymers leading to improved fire retardant properties together with low smoke generation, the process for manufacturing of such systems, the application of such systems on substrates and the use of such systems and resulting composites.

2. Description of the Background Art

Expanded or cellular polymeric structures based on organics became important in a lot of fields of application, such as in insulation against temperature gradients, noise shielding, vibration damping, lightweight construction etc. However, due to their organic, which means combustible nature, fire retardancy and the issues associated herewith always show to be an obstacle for broadening the applicability by approving organic foams and sponges for any use where flammability, flame spread and smoke generation might be a problem. Especially smoke creation and smoke density became an issue of discussion during recent years. A lot of efforts have been taken to improve the fire retardancy of the polymers themselves, however, these methods, e.g. using flame retardant agents, non-combustible fillers etc., only have a retarding, but not fully preventing effect and even may severely impact the expansion or foaming of the polymers as well as other final properties targeted for the application; additionally, as soon as there is a real burn and/or flashover (where temperatures easily will exceed 900° C. permanently) the organic polymer will continue burning no matter how much flame retardant agents were put into it, and the situation will get even worse when speaking about an organic foam where oxygen for accelerating the combustion is permanently present within the foam cells, and the cell walls are thin and easy to attack and decompose. Therefore, some work has been done to protect the expanded polymers already before they catch fire, i.e. from the side where a possible fire attack may arise, which means, on the surface(s) of the foamed product. A sector being very concerned by flammability issues are the cable and the building industry, and most of the examinations had indeed been carried out in these fields of application. One could think of composites where specially flame-protected polymers form the outer layer, as in e.g. JP 2002167886, U.S. Pat. No. 6,066,580, or GB 2122232, but the most widespread approach for fire protection is the use of an outer layer consisting of a metal foil or sheet, mostly aluminium due to applicability and cost issues, often together with one or more inner layer(s) showing no or low combustibility. This technology has been used to almost an exhaust in many varieties: in GB 2174335 (aluminium honeycombs filled with rigid foam), GB 2161655 (metal foil with mineral wool underneath), EP 91255 (foil layer, wire netting underneath), GB 1454493, U.S. Pat. No. 4,292,369 and U.S. Pat. No. 4,296,170 (outer foil in some varieties), DE 19815933 (perforated foil, fibres underneath), JP 2003055622 and JP 11293894 (foil together with intumescent systems). Most inventors claim the use of metal foil or sheet and fibres (woven or nonwoven) in conjunction, sometimes low-combustible fibres as in JP 200677551, JP 4347252, CN 2557778 (aluminium/polyester or polyamide), but mostly non-combustible fibres: JP 9177200, JP 8199709, JP 2043034, JP 10034786, JP 1261588, KR 102006022043, KR 102004065138, KR 100517732, EP 2116753, CN 201236395, U.S. Pat. No. 4,459,334, U.S. Pat. No. 4,204,019, U.S. Pat. No. 4,292,361 (all use metal (Al) foil as the outermost layer with (glass) fibre underneath), and US 20030077419 (foil with holes, fibres). The aluminium/fibre material combination is also claimed in JP 2002023763 for sound insulation purposes; in e.g. U.S. Pat. No. 4,937,125, JP 2215521, GB 1110579 and GB 1128611 for thermal insulation; in FR 2792667 and GB 1243136 for both purposes; a single aluminium foil layer is claimed in KR 102006115089 for waterproofing; however, in all a.m. cases fire performance is not targeted. Other inventors claim the use of low-combustible fibres (e.g. JP 2008201079, JP 80868164, CN 200992175) or non-combustible fibres (mainly glass fibres) only as an outer layer, sometimes in conjunction with other layers, such as in e.g. GB 882296 (glass fibre coating), EP 778634 (fibres in matrix, internal layer low-combustible material), DE 19815933 and SE 514501 (inorganic fibre layer, partially filled with non-combustibles), JP 10115045 (non-combustible fibre and bamboo layer), JP 8277586 (fibre on foam-filled honeycombs), GB 1386254 (fibre reinforced outer resin layer), DE 102006055377 and DE 19809973 (fibres/foils on intumescent layer). U.S. Pat. No. 4,025,686, U.S. Pat. No. 4,073,997, U.S. Pat. No. 4,118,533 and others claim glass fibres as outer layer, and GB 1213010 claims the use of multiple fibre layers for building a structure, but both do not target fire performance explicitly. CN 1613640 mentions a double felt layer with flame retardant impregnation; DE 19640887 claims a layer of fibre-reinforced silicate for fire protection purposes. All these methods indeed cover a large variety of requirements concerning flame retardancy; however, their individual versatility is limited and their performance is strongly depending on the substrate, on how the layers are applied etc. Therefore, most of the a.m. inventions require or at least mention flame retardant properties for the substrate itself, too. Requirements and flammability test related approvals within the building industry become more and more global, but also more precise and application-related and therefore more challenging (e.g. ASTM E-84, EN 13823), as smoke creation and density are considered in addition to the flammability. Accordingly, we found during our research that the a.m. prior art is not suitable to safely reach the highest possible flame retardancy classes for organics (e.g. BS 1 for EN 13823/EN 13501-1, V-0 for UL 94 etc.) even for the most widespread polymer foam bases, and in some cases these systems even lead to worse performance (see table 1). Systems that perform better (e.g. at least reaching BS 3 or V-1 class, respectively) showed to be expensive, complex and neither economic nor ecologic. A general deficiency of the a.m. materials is the fact that the flame retardant measures taken will lead to incomplete combustion, thus particles being content of the smoke leading to high smoke density, together with partially high smoke creation, too. There are other reasons for the fail of the traditional protection systems that are discussed below. Some prior art is not based on traditional systems: KR 102006021127 reveals composites with a protective polymer layer on an aluminium foil layer which itself is on top of foam, however, this system is not claimed for fire protection performance, and possibly would not match the respective requirements as the polymer is too easy burning. CH 650196 is describing an interesting composite said to be flame-retardant where the aluminium foil is perforated and being the second layer, covered by an outer layer of polyester fibres containing flame-retardants. Also the a.m. JP 8199709 is describing a system where the metal foil does not necessarily have to be the outermost layer. However, even these non-classic systems show deficiencies concerning applicability, reproducibility and consistency of the fire test results according to our research. For example, JP 8199709 correctly describes that the slow-burning outer layer containing flame retardant agents will disperse the heat of the burn by aid of the aluminium conductor beneath, however, we found that from a certain point of time on this dispersion ability is saturated and the overheating of the metal layer will cause an undesired flashover of both the outer layer and the substrate, leading to complete combustion of the composite around the foil. The composite mentioned in CH 650196 will show this effect at a slightly later point of time, but will end in a flashover anyway. The reason for the retarding of the flashover here is due to the perforation of the foil allowing the heat to disperse even into the substrate, but not up to a critical level where flammable gases would be formed. Eventually, also the correct assumption of GB 2222185 that a first layer that can melt away from flames would be of protective function showed to be of no use when applied for a.m. testing methods and approvals as the melt layer finally ignited spontaneously anyway. Additionally we observed significant creation of dark and/or dense smoke before and after the flashover in all three cases which would be another negative criterion concerning approvals.

### SUMMARY OF THE INVENTION

A major object of the present invention thus is to provide a fire protection system that is versatile, reliable, economic and easy to apply and will fulfil modern regulations in the respective application fields by dispersing flame and its heat to a maximum possible extent before it can reach or be transferred to the foam substrate, and suppressing the formation of smoke best way possible.

### BRIEF DESCRIPTION OF THE DRAWINGS

FIG. 1 schematically shows one embodiment of the invention.

### DETAILED DESCRIPTION OF THE INVENTION

Surprisingly, it is found that such a versatile material not showing the above mentioned disadvantages can be achieved when turning the state-of-the-art system round and using glass fibres as the outermost layer with a metal foil layer underneath, or when using a glass fibre layer on a second glass or low- to non-combustible fibre layer, both with appropriate properties for flame spread and heat dispersion, as well as for permeability for gases, but not for solid smoke particles

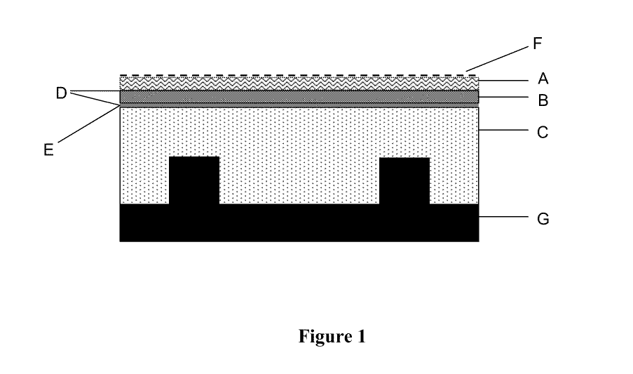

The claimed material contains compound (A), see FIG. 1, which is at least one glass fibre layer being applied as outermost layer, i.e. outer protective layer, on all surfaces of the substrate that bear the possibility of fire exposition, but at least applied e.g. on one side of a planar substrate, such as building and insulation panels. The glass fibres may be of any kind as available on the market, however, preferred are glass fibres with a non-organic treatment (e.g. silane based), as organic processing aids widely used in the yarn and textile industry (such as stearic acids, animal and vegetable fats and oils etc.) may have a negative impact on flammability. The fibre may be in the state of fabric or nonwoven. Preferred are tissue meshes including unidirectional weaves due to their better defined permeability/mesh size and due to their mechanical properties providing both surface strength and good internal and external bonding. A preferred mesh size for the tissue is 0.01 to 0.80 mm, especially preferred from 0.04 to 0.25 mm; a preferred thread density would be 5 to 250 threads per cm, especially preferred are 20 to 60 threads per cm.

The claimed material furthermore contains compound (B) as second outermost layer, i.e. inner protective layer, which is either at least one layer of non-perforated metal foil, preferably aluminium due to its good heat conductivity, good sealing property and excellent properties concerning the application (bonding/adhesion, compatibility etc.), wherein a preferred thickness range for the foil is 1-400 microns, especially preferred are 2-50 microns, or at least one layer consisting of fibres of either no combustibility, such as glass or mineral fibre, or low combustibility, such as polyaramide, flame-retardant polyamide or flame-retardant polyester, see FIG. 1. Preferred are glass fibres with inorganic treatment, especially preferred are such fibres as a fabric. A preferred mesh size for the tissue is 0.01 to 0.80 mm, especially preferred from 0.08 to 0.5 mm; a preferred thread density would be 5 to 250 threads per cm, especially preferred are 40 to 100 threads per cm.

The claimed material includes a substrate compound (C) underneath the (A) and (B), which is consisting of at least one layer of expanded polymer in a crosslinked and non-crosslinked state, such as, but not exclusively, organic foams and sponges (i.e. open cell and closed cell cellular polymers) of thermoplasts (e.g. polyolefins, polyesters including polyurethanes and PET/PBT, polyethers etc.) and thermosets (resins, e.g. phenolic, acrylic, melamine based etc.), thermoplastic elastomers (including PVC, PUR), elastomers (with backbones containing carbon only, or additionally oxygen, silicon etc., e.g. BR, SBR, NBR, IIR, ACM/AEM, FPM/FKM, EPM/EPDM, ECO, Q etc.), latices etc., see FIG. 1. The substrate (C) can consist of one of the a.m. compounds or of any combinations thereof. The substrate compound(s) forming (C) may contain any combination of fillers, fibres, crosslinking systems, plasticizers, stabilizers, colorants, foaming agents etc. and the like and any other additives that are used in the rubber and plastics industry, and may be existing as separate material layers or as one layer consisting of blends of materials, means, (C) can consist of at least one expanded layer and none to multiple expanded and unexpanded layers.

The claimed material contains a suitable system for adhesion (D) to bond the compounds (A), (B) and (C) to each other, respectively, see FIG. 1. Preferred are adhesion systems that are either fully compatible to the substrate to ensure good bonding (which means, based on the substrate's polymer compound or compounds being compatible with it) or preferably with intrinsic flame retardant properties. Especially preferred are adhesives containing halogenated or phosphorous compounds, e.g. being based on elastomers such as chloroprene, PVC, or the like. The adhesion system (D) does not have to be of same composition for bonding the layers (A) and (B) or (B) and (C), respectively, and can be freely chosen to match the individual requirements best possible.

The claimed material furthermore may contain additional functional layers (E) between (B) and (C) that can contribute both to the mechanical strength necessary for the intended application as well as to the fire retardant properties, see FIG. 1. The compounds for (E) thus may be e.g. fibres, foils, papers, sheet etc. in various forms, but also self-ceramifying, char-forming or intumescent compounds or compounds releasing flame-stopping or cooling or diluting substances, such as gas, vapour, liquids, halides etc., in case of fire. The compounds (E) may be bond to other compounds of the material by (D) or adhere by themselves.

The claimed material furthermore may contain additional functional layers (F) as covering on (A) to act e.g. as a shielding, a reinforcing or as a decorative layer, see FIG. 1. Preferred are layers that will either be flame-retardant themselves or easily be burning or melting away so not to disturb the functioning of the (A) (B) (C) layer system. The compounds (F) may be bond to other compounds of the material by (D) or adhere by themselves.

The claimed material furthermore may contain any further element (G) necessary for the intended application, such as wire inlays in case of cables or the like, massive parts such as wood, glass, metal or concrete structures for building purposes etc., see FIG. 1. The compounds (G) may be bond to other compounds of the material by (D) or adhere by themselves.

A major advantage of the claimed material is its suitability for “fire critical” applications where low flame spread and/or low smoke generation are required (e.g. ASTM E-84, EN 13823/EN 13501-1, see Table 1). The effect ranging from flame-retardant to even flame-preventing is provided by the special effect the layers of the claimed material will generate on the formation and on the migration of flammable gases in combination with the flame and heat dispersion, according to our results:

1. When hitting the first layer of fabric the flame is dispersed over a high surface and the net heat creation per surface unit thus is lowered significantly in comparison with smooth and/or closed surfaces, such as foil or sheet. Also the heat penetration into the composite is lower due to the mentioned dispersion, but also due to the low heat conductivity of the fibre in comparison with metal foils or polymeric layers.

2. When approaching the second layer the already weakened heat and flame will be either

a. reflected by the metal foil or be further dispersed by the second fabric layer. In case the heat would penetrate deeper into the foam part of the composite the resulting combustible gases will either be entrapped by the foil (tear of the foil due to gas pressure is prevented by the outer fibre layer, a phenomenon which is also not provided by prior art) and thus being kept away from possible flashover;

b. or the second fabric layer will slow down the migration of these gases to the surface or flame front.

Both effects 2a and 2b will prevent a flashover and together with 1 will result in a controlled slow, burn (slow, but supplied with sufficient oxygen) that will not create much smoke in comparison with standard flame retardant systems that will lead to a “suppressed” burn (insufficient oxygen) with high smoke creation due to incomplete combustion (compare Table 1: SMOGRA and TSP values, Table 2: improvement of SMOGRA values by applying the claimed system).

A very prominent advantage of the claimed material is its versatility concerning the fire tests and the results being almost independent from the substrate (see Table 2).

A further advantage of the claimed material linked to a.m. advantage is the fact that no additional measures have to be taken to render the substrate fire retardant (see e.g. PET in table 2).

This leads to a further advantage of the claimed material which is the free and economic as well as ecologic choice for foam substrate and its ingredients.

This leads to another advantage of the claimed material as no halogenated fire retardants are needed to achieve demanded flame resistance. Especially brominated flame retardants are critical for environmental issues and can generate toxic fumes in case of fire. For that reason brominated flame retardants are already partially prohibited.

A further advantage of the claimed material is the fact that in its preferred compositions it is free of both fibres and PVC, both of them being under survey and being discussed for environmental and health issues.

A further advantage of the claimed material is that its flame retardant properties are almost independent from the geometry of the part to be fire protected.

A further advantage of the claimed material is the possibility to adapt its properties to the desired property profile (concerning mechanics, damping, insulation, flexibility, etc.) by adaptation of the foil thickness and/or the fibre diameter, length, tissue den, braiding angle etc.

It is a prominent advantage of the claimed material that it can be produced in an economic way in a continuous process, e.g. by extrusion and co-lamination. It shows versatility in possibilities of manufacturing and application. It can be extruded, co-extruded, laminated, moulded, co-moulded, overmoulded, welded etc. directly as a multilayer system and thus it can be applied in unrestricted shaping onto various surfaces in automotive, transport, aeronautics, building and construction, furniture, machinery engineering and many other industries, even by a thermoforming or other shaping methods following the manufacturing process of the material.

It is a further advantage of the claimed material that it can be transformed and given shape by standard methods being widespread in the industry and that it does not require specialized equipment.

Another advantage of the material is the fact that the compound (C) can contain scrapped or recycled material of the same or other kind to a very high extent not losing its fire retardant properties (see Table 2.).

A further advantage of the claimed material is its wide temperature range only being determined by the expanded polymer. As an example, a claimed material with expanded silicone elastomer (MVQ) as compound (C) may be used from −100° C. up to +300° C., or up to 400° C. with thermoset foams.

A further advantage of the claimed material is its suitability for thermal and sound/vibration insulation applications, ranging from very low to very high temperatures as mentioned above, with the additional advantage that aluminium foil will act as a vapour barrier and as a reflector and glass fibre acts as an additional insulation layer.

A further advantage of the claimed material is its impact resistance against mechanical load, pressure, notch formation, cuts and bites, including attack by rodents or termites or the like, which is another advantage for outdoor insulation purposes.

### Examples

In the following examples and comparative examples the required foams were acquired on the market (class 0=class0/Armaflex®, Armacell. Ltd., Oldham; AF=AF/Armaflex®, Armacell GmbH, Munster; same polymer base, but varied additives) or being produced according to state of the art procedures to 25 mm thickness samples. The protective layers were put on the foam parts by slight and constant pressure using adhesives or the like that were available on the market (Hapuflam®: fire protection multilayer fabric system, Hapuflam GmbH, Zellertal; Flammotect: fire protection paint/coating, b.i.o. Brandschutz GmbH, Seevetal, both self-adhesive, others: Adhesive 520, Armacell GmbH, Munster). In the case of the comparative examples the layers were applied as close as possible to the processing provided by the respective literature.

TABLE 1
flammability test results of foam compounds according to EN 13823/EN
13501-1 (single burning item/round corner test): flammability and determination of Total
Heat Release (THR), Fire Growth Rate (FIGRA), Smoke Growth Rate (SMOGRA) and Total
Smoke Production (TSP) by EN 13823; flammability classification in accordance with EN
13501 (best individual classifications: B, S1, d0). The examples without asterisks comprise
claimed material

| | Protective | | | | | | | | | |
|---|---|---|---|---|---|---|---|---|---|---|
| | layers | | | | | | | | | |
| Foam | *= comparative | | THR | figra | Figra | | TSP | | class | |
| base | example | Figra | 600 | 0.2 | 0.4 | Smogra | 600 | class | SMOGRA | D class |
| Melamine | alum. foil* | 330 | 1.0 | 345 | 330 | 24 | 44 | D | S1 | d0 |
| | alum. foil + glass | 0 | 0.3 | 0 | 0 | 0 | 29 | B | S1 | d0 |
| | fibre | | | | | | | | | |
| EPDM | none* | 779 | 8.3 | 779 | 779 | 1286 | 1121 | E | n.a. | n.a. |
| | alum. foil* | 521 | 10.5 | 521 | 521 | 587 | 1306 | D | S3 | d0 |
| | glass fibre* | 128 | 4.0 | 149 | 128 | 263 | 436 | C | S3 | d0 |
| | 2x glass fibre | 0 | 0.9 | 0 | 0 | 12 | 97 | B | S2 | d0 |
| | alum. foil + glass | 5 | 1.1 | 5 | 5 | 0 | 22 | B | S1 | d0 |
| | fibre | | | | | | | | | |
| Class 0 | none* | 146 | 2.9 | 257 | 146 | 1151 | 315 | C | S3 | d0 |
| | glass fibre* | 84 | 1.2 | 41 | 84 | 335 | 286 | B | S3 | d0 |
| AF | none* | 76 | 2.1 | 76 | 33 | 1891 | 413 | B | S3 | d0 |
| | PTFE + glass | 648 | 2.3 | 654 | 648 | 544 | 379 | D | S3 | d0. |
| | nonwoven* | | | | | | | | | |
| | Hapuflam fabric + | 156 | 3.0 | 169 | 156 | 49 | 197 | C | S2 | d0 |
| | Hapuflam CP* | | | | | | | | | |
| | Flammotect S* | 271 | 4.7 | 278 | 271 | 272 | 527 | D | S3 | d0 |
| | Flammotect A* | 610 | 3.3 | 627 | 610 | 476 | 486 | D | S3 | d0 |
| | alum. foil* | 90 | 3.6 | 170 | 90 | 368 | 418 | C | S3 | d0 |
| | glass fibre + alum. | 147 | 2.4 | 147 | 96 | 121 | 368 | C | S3 | d0 |
| | foil* | | | | | | | | | |
| | alum. foil + glass | 0 | 1.0 | 0 | 0 | 36 | 101 | B | S2 | d0 |
| | fibre | | | | | | | | | |
| NBR | none* | 643 | 6.3 | 697 | 643 | 438 | 183 | D | S3 | d0 |
| | 2x glass fibre | 73 | 2.0 | 73 | 29 | 50 | 113 | B | S2 | d0 |
| | alum. foil + glass | 0 | 1.6 | 0 | 0 | 18 | 30 | B | S1 | d0 |
| | fibre | | | | | | | | | |

TABLE 2
fire test according to EN 13823/EN 13501-1 using the claimed system
(A) (B) (C) with different foam layers (C), carried out on sheet-shaped
material. The examples without asterisks comprise claimed material

| | Protective layers | | class | D |
|---|---|---|---|---|
| Foam base | *= comparative example | class | SMOGRA | class |
| Melamin | none* | C | S3 | d0 |
| (thermoset) | alum. foil + glass fibre | B | S1 | d0 |
| EPDM (rubber) 1) | none* | E | n.a. | n.a. |
| | alum. foil + glass fibre | B | S1 | d0 |
| NBR/PVC | none* | C | S3 | d0 |
| (rubber/TPE) 1) | alum. foil + glass fibre | B | S2 | d0 |
| NBR | none* | D | S3 | d0 |
| (nitrilbutadiene | alum. foil + glass fibre | B | S1 | d0 |
| rubber) | | | | |
| MVQ | none* | D | S1 | d0 |
| (Silikonkautschuk) | alum. foil + glass fibre | B | S1 | d0 |
| PET (thermoplast) + | none* | D | S3 | d1 |
| flame retardant | alum. foil + glass fibre | B | S1 | d0 |
| agent | | | | |
| PET | none* | E | n.a. | n.a. |
| (thermoplast) 1) | alum. foil + glass fibre | B | S1 | d0 |
| PET, based on | none* | E | n.a. | n.a. |
| recycled material + | alum. foil + glass fibre | B | S1 | d0 |
| flame retardant | | | | |
| agent | | | | |
| PET, based on | none* | E | n.a. | n.a. |
| recycled material | alum. foil + glass fibre | B | S1 | d0 |

1) The systems based on NBR/PVC, EPDM and PET have been tested according to ASTM E84 standard (tunnel burn test) reaching the classification 25/50 (best in class).

1. A material comprising an expanded polymer as a core being covered with at least one inner protective layer comprised of a metal foil or glass fibres and with at least one outer protective layer comprised of glass fibres.

2. The material according to claim 1 wherein the metal foil is aluminium.

3. The material according to claim 2 wherein the thickness of the aluminium foil is 1-400 microns.

4. The material according to claim 1 wherein the glass fibre is in a form of a weave fabric, knitted fabric or unidirectional weave.

5. The material according to claim 4 wherein the glass fibre is coated by non-organic substances.

6. The material according to claim 1 having a mesh size of 0.01 to 0.80 mm.

7. The material according to claim 1 having a thread density of 5 to 250 threads per cm.

8. The material according to claim 1 wherein the layers are bonded with an adhesive.

9. The material according to claim 8 wherein the adhesive has flame-retardant properties.

10. The material according to claim 9 wherein the adhesive is based on chloroprene.

11. The material according to claim 1 wherein additional layers are applied for at least one of reinforcement and decoration purposes.

12. A process for manufacturing the material according to claim 1 in a continuous process.

13. A process for manufacturing the material according to claim 1 in a continuous two-step-extrusion and lamination process.

14. A method of protecting a product comprising applying to said product a material according to claim 1 for protection purpose.

15. The method of claim 14 for protection against at least one of temperature, fire noise/vibration.

16. The method of claim 14 for at least one of thermal insulation, acoustic insulation, acoustic dampening insulation, vibration damping insulation, or fire protection insulation.

17. The method of claim 14 for at least one of thermal insulation, sound insulation, or fire protection insulation, at least one of inside and outside of at least one of structures, vessels, containers, pipes, walls, ceilings, floors, roofs, tanks, tubes, and ducts.

18. The material of claim 3, wherein the foil thickness is 2-50 microns.

19. The material of claim 6 having a mesh size of from 0.04 to 0.25 mm.

20. The material of claim 7 having a thread density of 20 to 60 threads per cm.
